(19) United States
(12) Patent Application Publication
(10) Pub. No.: US 2002/0076142 A1
(43) Pub. Date: Jun. 20, 2002

(54) Optical switch and switching network

(76) Inventor: Qi wang Song, Fayetteville, NY (US)

Correspondence Address: BROBECK, PHLEGER & HARRISON, LLP, ATTN: INTELLECTUAL PROPERTY DEPARTMENT, 1333 H STREET, N.W. SUITE 800, WASHINGTON, DC, 20005, US

(21) Appl. No.: 09/933,122

(22) Filed: Aug. 21, 2001

Related U.S. Application Data
(60) Provisional application No. 60/226,571, filed on Aug. 21, 2000.
(60) Provisional application No. 60/233,485, filed on Sep. 19, 2000.

(51) Int. Cl. G02B 6/35

(52) U.S. Cl. 385/22; 385/16

(57) ABSTRACT

A non-blocking N×M cross-connect optical switching device, system, and method having any number of inputs (N) and any number of outputs (M) is disclosed. In an embodiment of the invention, low power loss waveguides and low power loss electro-optical material switching elements are combined into a compact planar device. Depending on the direction of the electric field applied, the refractive index of a switching element is varied to alternate between a transmission state when the refractive indexes of the waveguides and electro-optical material are substantially equal and a reflective state when the refractive indexes are not equal. The transmission state allows input light to pass through a switching element to an output port. The reflective state does not allow light to pass through, thereby directing incident light to an alternative output port. Other embodiments comprising thermal optical materials as switching element are also described.

### RELATED APPLICATIONS

The present invention claims priority to U.S. Provisional Patent Application No. 60/226,571, filed on Aug. 21, 2000, and U.S. Provisional Patent Application No. 60/233,485, filed on Sep. 19, 2000, both of which are entirely incorporated herein by reference.

### BACKGROUND OF THE INVENTION

1. Field of the Invention

The invention relates to optical communications. More particularly, the invention relates to optical switching devices, systems, and methods.

2. Description of the Related Art

The fundamental problem facing telecommunication carriers today is satisfying the increasing bandwidth needs of users already plagued by communication channels having high data traffic volumes. Telephone usage accounts for some of the increase due to proliferation of facsimile machines and mobile phones. Nevertheless, the most dramatic growth has been from the ever increasing amount of Internet traffic, which roughly doubles each year. This trend is likely to accelerate as broadband access technologies such as digital subscriber lines (“DSL”) and cable modems are embraced by consumers. Demand will likely soar even further should digital video, particularly, two-way video communications, becomes commonplace.

In the face of competition, carriers need to vastly increase capacity while reducing costs and maintaining quality provisioning services. In the past decade, carriers have laid a meshed fiber optic communication network that revolutionized the industry by transmitting data, voice, and images by the passage of light through thin, transparent optical fibers. When compared to conventional copper coaxial cables, fiber optic cables have many advantages including high data transmission capacity, low material cost, low signal attenuation, data security, chemical stability, and immunity from electromagnetic interference. However, despite these improvements, particularly in bandwidth, data, video, and voice signals now crowd existing fiber optic transmission systems that had ample space just a few years ago.

Dense wavelength division multiplexing (“DWDM”) is a technique to pack more information into existing optical cable by simultaneously sending separate signals through the same optical fiber at different wavelengths. In operation, the optical transmission spectrum is divided into a number of mutually exclusive wavelengths, each supporting a single communication channel operating at a desired bit-rate. The coexistence of multiple DWDM channels on a single fiber greatly increases the bandwidth over a single wavelength channel. Dense wavelength division multiplexing has been widely accepted and is able to carry eight (8) or more wavelength channels on a single fiber. Compared with the alternative of adding new fiber, DWDM technology provides an effective way to add capacity.

DWDM has only recently become practical because of the development of Erbium-doped fiber amplifiers (“EDFA”). Because light signals traveling through transparent optical fibers fade to undetectable levels after approximately a hundred miles, they need to be amplified. Unlike an opto-electronic regenerator, an Erbium-doped fiber amplifier operates directly on the light, i.e., the input light signal stimulates excited erbium atoms to emit more light at the same wavelength. Further, because the wavelength of the optical signals are preserved, erbium fiber devices are particularly well suited for DWDM because they can amplify several different wavelength channels simultaneously while eliminating scrambling associated with opto-electronic regenerators. When combined with DWDM technology, chains of Erbium-doped fiber amplifiers create the necessary information “pipelines” with vast amounts of bandwidth to connect communication hubs, e.g., metro areas, over thousands of miles spanning across states, countries, continents, and even oceans.

For DWDM to reach its full potential, however, more than packing in additional wavelengths will be needed. Specifically, the real information revolution will not come until cheap DWDM pipelines reach individual residences within a metropolis. For example, in the “metro market,” the signal that emerges from the optical pipe is generally converted to an electronic format and then transmitted to consumers via telephone lines, coaxial cable lines, local area networks, combinations thereof, etc. Because even the fastest electronic transmission line has a substantially smaller bandwidth than DWDM, electronic devices such as, routers and modems, create bottlenecks of information. Thus, consumers aren't able to fully “tap” into the huge optical pipeline.

Optical switching networks that perform fiber switching and wavelength switching, are necessary for switching and manipulating optical wavelengths upon emerging from the optical pipeline. In particular, for DWDM to be fully appreciated, wavelengths need to be reallocated and reassigned to emulate what happens in electronic digital cross-connects. For example, it is impossible to allocate the same wavelength to one customer throughout the entire system because the huge network has far more customers than it has wavelengths. Further, scalability is achieved by using each wavelength many places in the network at the same time. Moreover, channeling the energy transmitted by each node along a restricted path to the receiver can avoid wasting transmitting power. For example, each intermediate node between the pipeline and the receiver directs light coming into one port at a given wavelength out of one and only one port. Thus, allowing an optical layer to be substituted for the present physical layer of protocol stacks, e.g., TCP/IP and ATM.

Conventional techniques for performing fiber and wavelength switching have a number of inherent inadequacies. One such switching technique involves a waveguide fabricated from thermo-optical material. The refractive indexes of thermo-optical materials exhibit a wide variation in value with respect to temperature. When a thermo-optical waveguide is heated, refractive index variations alter the phase of the signal propagating in the waveguide, or alter the guiding properties of a waveguide itself. Therefore, light traveling through the waveguide can be blocked by heating the waveguide. Other approaches incorporating thermo-optic materials include Mach-Zehnder interferometers, directional couplers, Y-splitters, and X-splitters. However, conventional thermo-optical switch devices, in general, suffer from high power loss and slow switching speed. In addition, they require high power to heat the thermo-optical materials. Another major drawback of thermo-optical devices concerns the positioning and geometry of the heater element. Generally, if the heater is not positioned accurately in a themo-optical switching device, or the geometry of the heater is not within proper design tolerances, thermal isolation between switching arms will be inadequate, and unacceptable optical cross talk between output ports will result. Moreover, the process of accurately positioning the heating elements on the waveguide switch devices is expensive and time-consuming.

U.S. Pat. Nos. 5,699,462 and 6,198,856 describe a switch featuring a switching element to be changed, through the operation of heaters within the switch element, so as to cause a gas, or bubble, to be formed within the switch element. When present in the switch element, the bubble causes a refractive index mismatch between a waveguide and the switch element, thus causing the light in the waveguide to be reflected onto an intersecting waveguide. However, the use of a gas bubble as a switching element is not efficient because switching speed is slow, e.g., 1-10 ms, and high optical loss results from the curved surface of the bubble. Moreover, this type of technique is expensive because incorporating gas into a switching element, e.g., blowing a bubble, makes manufacturing difficult. Further, bubble technology is not easily integrated into optical systems.

Microelectromechanical (“MEM”) switching devices route optical signals between input and output ports through numerous mirrors that reflect or cancel light. Each mirror mechanically moves with two degrees of rotational freedom. However, because these switching devices employ small moving mechanical parts, manufacturing is complicated, and therefore expensive with poor yield, e.g., three (3) out of a thousand are functional after fabrication. Moreover, MEM switches have the disadvantage of large power loss, e.g., 15 dB, and slow switching speed, e.g., 30 ms.

Optical fiber is expanding closer to end-users to meet their broadband multimedia requirements. DWDM improves signal transmission in the metro market by carrying signals in their original digital format rather converting them into a plurality of electronic formats. Because such conversion requires costly electronics, it can be cheaper to dedicate an optic wavelength for transmission in the original format. However, for consumers to fully reap these and other rewards of DWDM technology, faster, more reliable, and cheaper optical fiber and wavelength switches need to be developed.

### SUMMARY OF THE INVENTION

The present invention is an optical cross connect switch device and switching method based on a simple, elegant, and unique optical fiber switching and wavelength switching concept. Particularly, this concept comprises refractive index matching of low power loss waveguides with a low power loss active material, e.g., an electro-optical material, switching element. By varying the electric field applied, the refractive index of the switching element is changed between two refractive index states. The first refractive index state corresponds to a refractive index substantially equal to the refractive indexes of the optical waveguides. In this state, the electro-optical material transmits substantially all incident light through to an output waveguide. The second refractive index state corresponds to a refractive index less than that of the waveguides. In this state, the electro-optical material does not allow light to be transmitted through the switching element, but rather reflects substantially all the light by internal reflection along another optical pathway.

It is a feature of the invention that the switching devices and systems described herein can be effected in a planar device or optical “chip” fabricated on a wafer substrate.

An advantage of an optical chip is its compact size, straightforwardness to fabricate, relative low cost, and simplicity to integrate into more complex optical communication systems.

The present invention is well suited for optical communication and switching systems, interconnects, and fiber based network products employing fiber switching (sometimes referred to as wavelength routing), i.e., any optical wavelength on any input fiber can be directed to any output fiber. In an embodiment of the invention, a N×M integrated cross connect system comprises any number (N) of input fibers and any number (M) of output fibers with any of the optical wavelengths, λᵢ, on the input fiber being directed to any of the output fibers.

An advantage of the inventive cross connect system is that and is fully scalable, at least within 1,000×1,000 scale.

The present invention radically improves speed, reliability, and cost efficiency of optical switches as compared to current optical switching technologies. The present invention provides fiber and wavelength switching systems that allow optical signals to be sorted, monitored, and manipulated by wavelength, thereby streamlining the operation of fiber-optic networks and permitting consumers to reap all the benefits of DWDM communications.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the following descriptions taken in connection with the accompanying drawings in which:

FIG. 1A depicts a top level view of a 1×4 optical cross-switch according to an embodiment of the invention;

FIG. 1B depicts a top level view of the 1×4 optical cross-switch with preferred waveguide angle bends;

FIGS. 2A-B illustrate a cross-sectional view and operation of an electro-optical switch according to an embodiment of the invention;

FIG. 2C shows a flowchart of an optical chip fabrication method according to an embodiment of the invention;

FIG. 2D illustrates a cross-sectional view of an electro-optical switch with cladding layers according to an embodiment of the invention;

FIG. 2E shows a flowchart of an optical chip fabrication method according to an embodiment of the invention;

FIG. 3 depicts a 1×2 optical switch according to an embodiment of the invention;

FIG. 4 illustrates a 32×32 optical cross-connect switching system according to an embodiment of the invention;

FIG. 5 shows an 1×4 fiber switching system according to an embodiment of the invention;

FIG. 6 illustrates 4-fiber×4-fiber, 32-channel, out-band locally-controlled and fully connected, optically transparent data router with amplification according to an embodiment of the invention; and

FIG. 7 depicts a 4-fiber×4-fiber, 32-channel, in-band-controlled (self routing) fully connected optically transparent data router according to an embodiment of the invention.

### DETAILED DESCRIPTION OF PREFERRED EMBODIMENTS

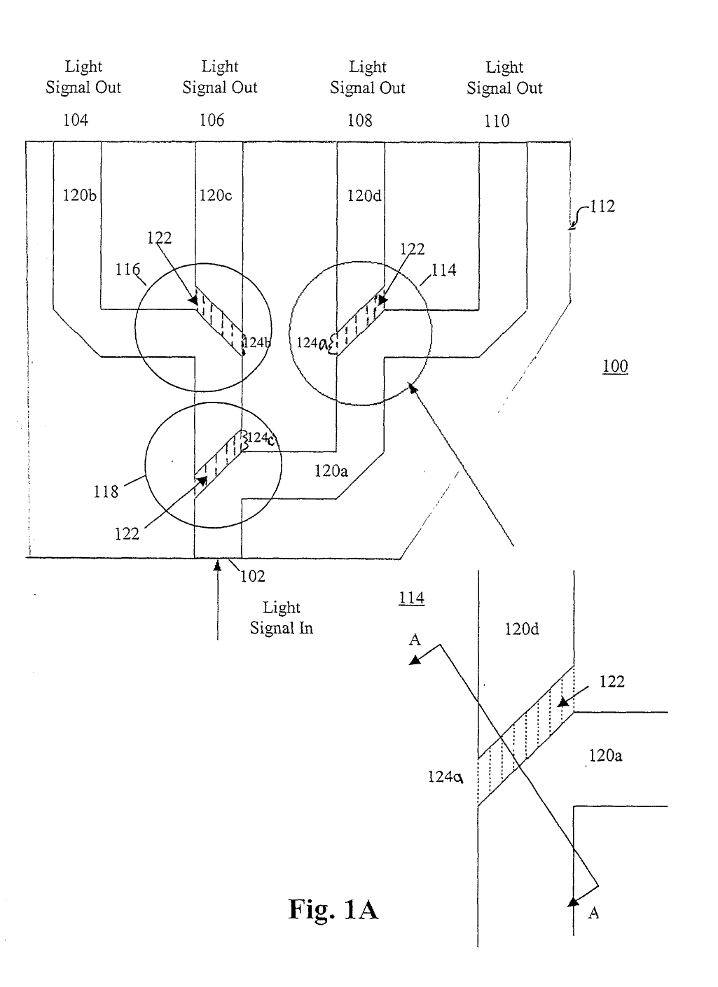

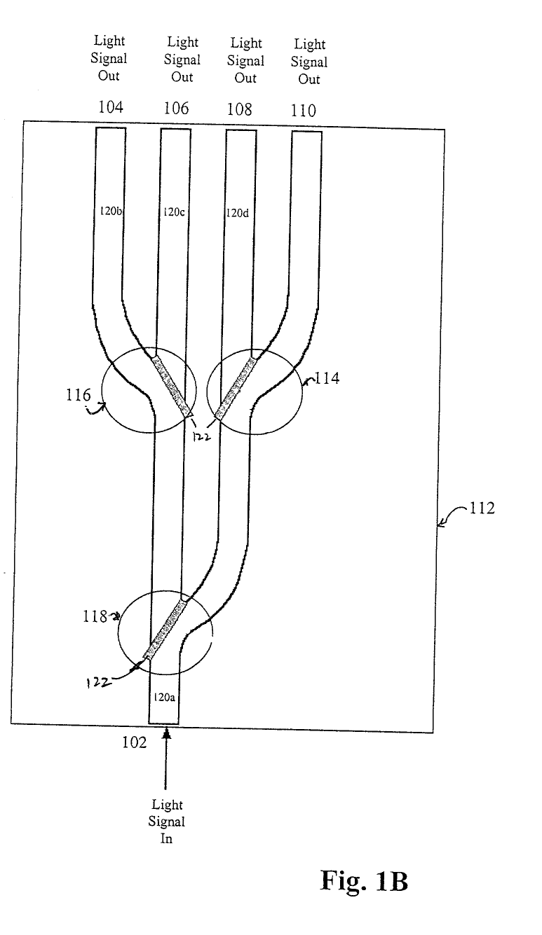

Preferred embodiments of the present invention and their advantages may be understood by referring to FIGS. 1-7, like numerals being used for like corresponding parts in the various drawings.

The present invention is directed to non-blocking N×M cross-connect optical switch devices, systems, and methods having any number (N) of inputs and any number (M) of outputs. Particularly, the invention combines low power loss waveguides with low power loss active materials having electro-optical or thermo-optical properties, and a variable index of refraction (“refractive index.”). Depending on the respective electric or thermal field applied, the refractive index of the active material is varied to alternate the material between a transmission state when the refractive indexes of the waveguides and active materials are substantially equal (herein referred to as “refractive index matching”) and a reflective state when the refractive indexes are not equal. The transmission state allows input light to pass through the active material to an output port. The reflective state does not allow light to pass through, thereby directing input light to an alternative output port. Unlike conventional switching methods that employ a single material with large power loss or multiple materials with at least one having a large power loss, the present invention combines two low loss materials to perform switching based on internal reflection and refractive index matching of the two materials.

The preferred embodiments are discussed in the context of employing an electro-optical material (“E-O material”) in the form of a substantially homogeneous liquid crystal, polymer, or other suitable substance. Preferably, E-O materials utilized with the present invention should have the following characteristics: 1) a large refractive index change, e.g., preferably in the range having a maximum of 1.50 and a minimum of 1.42; and 2) fast switching response time, e.g., 10⁻³ to 10⁻⁷ seconds. Examples of E-O materials include Merck 18523 manufactured by EM industries, Inc. As would be appreciated by one of ordinary skill in the art, however, the specific E-O material may vary from application to application. In general, use of E-O material is advantageous because it typically has a wide range of wavelengths to which the material is transparent, particularly in the optical communication range of 1300 nm to 2000 nm; is relatively cost effective; and readily suitable for device fabrication. Nevertheless, thermo-optic materials (“T-O materials”) and other appropriately active materials may also be used with the invention. Examples of T-O materials include thermal curable ZP1010 and 2154 series polymers manufactured by Zen Photonics CO., LTD.

In the preferred embodiments of the invention, switch junctions and optical waveguides are integrated into a planar device or “chip” that is fabricated on a substrate or wafer. Preferably, these chips are compact in size, e.g., waveguide height and width are on the order of 10 and 5 microns, respectively. Compact chips are particularly suitable for optical communications because they of the small size and easy integration in optical systems. Further, optical chips are relatively inexpensive to produce. Because a plurality of functional elements can be implemented in one planar device, the invention can be employed in a wide variety of optical networking systems. In other embodiments, the waveguides can be fabricated from conventional optical fiber.

FIG. 1A depicts a top level view of a 1×4 optical cross-switch 100 according to an embodiment of the invention. Optical switch 100 includes an input port 102 and four output ports 104-110. Optical switch 100 is fabricated on a wafer substrate, such as silicon or quartz. Optical switch 100 includes switch junctions 114, 116, and 118 and a web of optical waveguides 120a-d deposited on the wafer which serve as conduits to transport light signals from input port 102 to output ports 104-110 through switch junctions 114, 116, and 118. Preferred waveguide materials include well-known doped silica, sol gel produced materials, silica crystal, polymers, or a combination thereof.

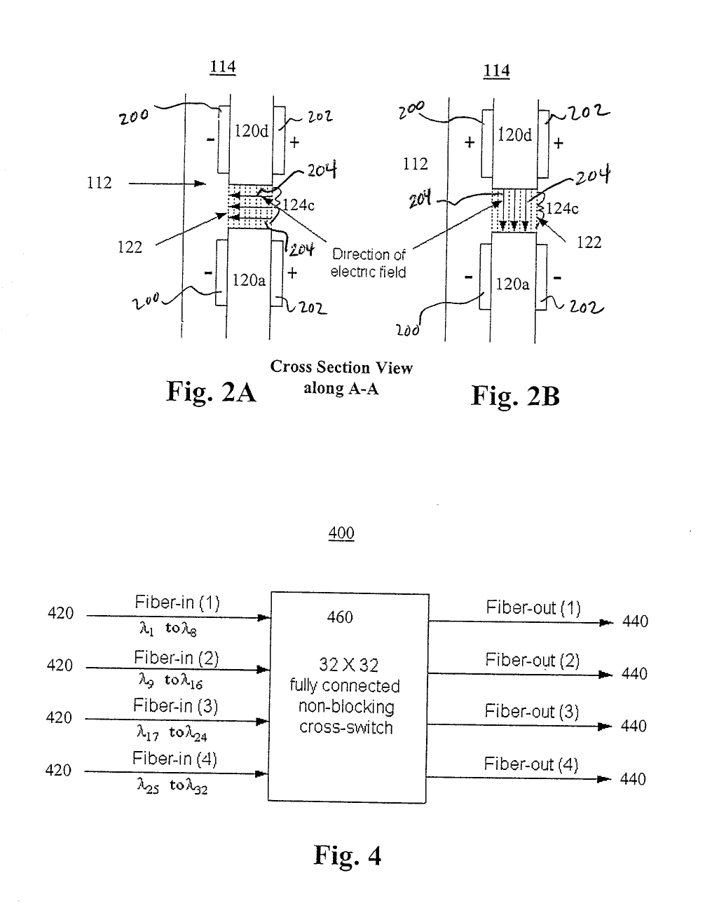

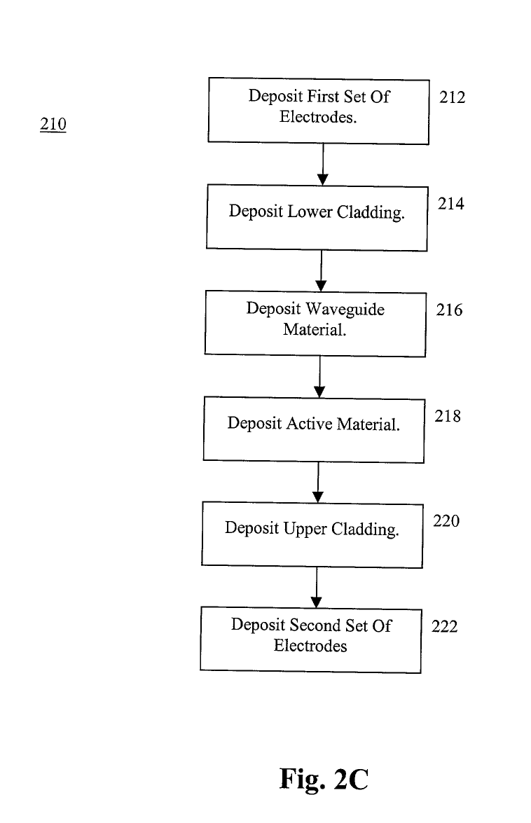

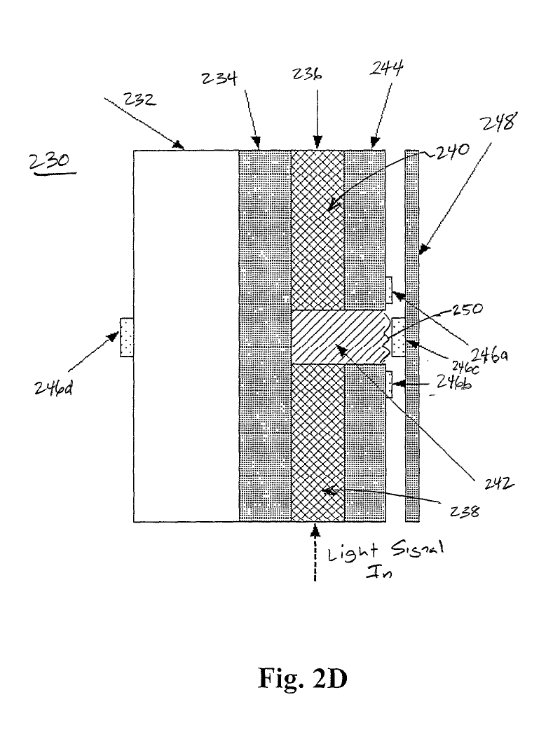

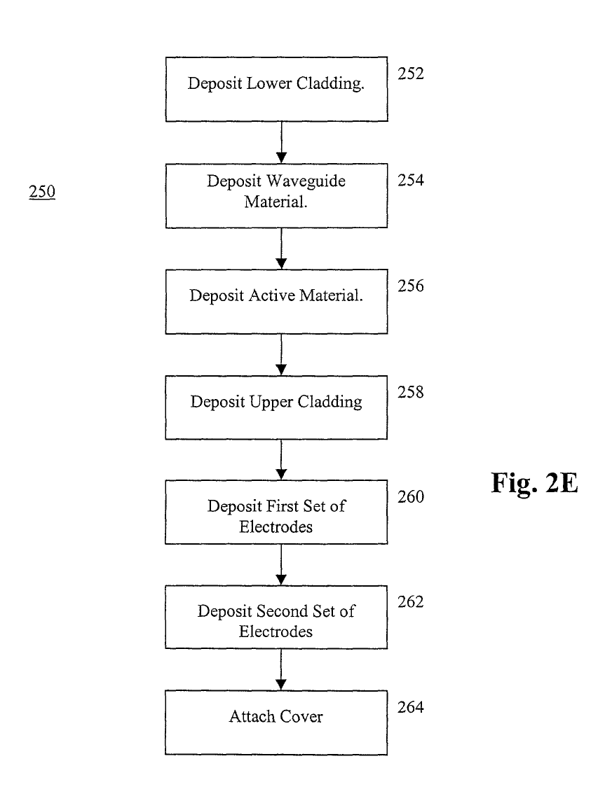

In this embodiment, switch junctions 114, 116, and 118 each include E-O material 122 which is deposited into gaps 124a-c, respectively. Gaps 124a-c are formed to intersect optical waveguides 120a-d. As discussed below, each switch junction 114, 116, and 118 also includes electrodes (not illustrated in FIG. 1A). FIGS. 2A-B illustrate a cross-sectional side view of switch junction 114 taken along the axis A-A depicted in FIG. 1A. As illustrated, switch junction 114 includes a first and second set of electrodes 200 and 202, respectively, above and below waveguides 120a and 120d, respectively. In FIGS. 2A-B, the bottom of substrate 112 is shown on the far left. In other words, moving from left to right in these figures corresponds with moving from the bottom to the top of the wafer. The first set of electrodes, 200, are deposited in cavities formed, punched, or stamped into substrate 112. The height electrodes 200 are preferably made flush with the top surface of substrate 112. The next layer is a bottom cladding layer (not shown), which insulates waveguides 120a and 102d from substrate 112. A core layer includes waveguides 120a and 120d and E-O material 122. Above the core layer, is a top cladding layer (not shown). The bottom and top cladding layers preferably comprise doped SiO₂. The second set of electrodes, 202, is formed above the top cladding layer. Electrodes 200 and 202 are preferably controlled independently by off-chip circuitry and connected electrically by metal bonding.

The number of possible planar optical switch geometries is only limited by the physical restrictions of the fabrication techniques used. A preferred method 210 of fabricating a planar device according to the invention is illustrated in FIG. 2C. Particularly, this optical chip fabrication method comprises the steps of: depositing (step 212) a first set of electrodes on substrate; depositing (step 214) a lower cladding; depositing (step 216) waveguide material to construct web of waveguide sections; depositing (step 218) the active material, e.g., E-O material or T-O material, at the optical junctions, i.e., gaps, adjoining the waveguide sections; depositing (step 220) an upper cladding; and depositing (step 222) a second set of electrodes. These depositing steps are implemented using lithography or other conventional techniques. As it would be apparent to one of ordinary skill in the art, a specific configuration and geometry of the switch will dictate the locations where the electrodes are deposited.

In another embodiment of the invention, the electrodes are placed outside the cladding layers as shown in FIG. 2D. This figure shows a cross-sectional view of switch-junction 230. Gap 250 is filled with E-O material 242, preferably a polymer or liquid crystal. Lower cladding 234 is disposed in between substrate 232 and core layer 236 comprising waveguides 238 and 240, and E-O material 242. Above core layer 236 is upper cladding 244. Electrodes 246a, 246b, and 246c are disposed on top of upper cladding layer 244 and below glass cover 248 preferably comprising a surface alignment coating on the bottom surface. Electrode 246d is disposed on a surface of substrate 232 opposite to the surface in contact with cladding 234. Electrode-pair 246a and 246b, and the electrode-pair 246c and 246d are driven by two independent (either in time domain or frequency domain) alternating voltage power supplies (not shown). Accordingly, the orientation and the strength of the electrical field on the E-O material can be controlled. Combing this effect with that of the surface alignment coating on the cover glass, the refractive index of the E-O material can be controlled to provide the required optical switching, i.e., changing the direction of the light propagation.

In an alternative embodiment of the invention, the E-O material is replaced with a T-O material, e.g., thermal-optical polymer or thermal-optical liquid crystal, and only electrode 246a is used, i.e., electrode 246a serves as a heating element to control the refractive index in the gap, thereby inducing the required switching at the gap.

Planar devices such as the aforementioned embodiment comprising electrodes disposed outside the cladding are fabricated by method 250 illustrated in FIG. 2E. Method 250 comprises the steps of: depositing (step 252) a lower cladding on a substrate; depositing (step 254) waveguide material to construct web of waveguide sections; depositing (step 256) active material at the optical junctions, i.e., gaps, adjoining the waveguide sections; depositing (step 258) an upper cladding; depositing (step 260) a first set of electrodes on the outside surface of the upper cladding; and (step 262) depositing a second set of electrodes. The second set of electrodes are equally divided into two groups. One group is deposited on the outside bottom surface of the substrate and the other on an inside surface of a cover glass. The two groups of the second sets of electrodes are properly aligned with each other by an alignment coating of the inner surface of the cover glass. Upon completion of these steps, the cover glass is attached (step 264) to the upper cladding.

The operation of switch junction 114 is now discussed with reference to FIGS. 2A and 2B. Switch junction 114 reflects light signals from input port 102, thereby maintaining light signals in waveguide section 120a and routing the signals to output port 110, or allows light signals to pass through switch junction 114 to waveguide 120d and thus to output port 118. This is accomplished by changing the electric field applied to E-O material 122. Due to the optical properties of E-O material 122, the refractive index varies in the two orientation conditions, i.e., the refractive index depends on the relative orientation between the molecule alignment and the transmission axis. In one of the conditions, typically for most electro-optical materials when the electrical field is perpendicular to the transmission axis, the refractive index of the electro-optical material matches the refractive index of waveguides 120a and 120d. Under the other condition, the refractive index of the electro-optical material is much lower than that of waveguide 120a and 120d. In operation, the electrical field at switch junction 114 is changed by alternating the polarity electrodes 200 and 202, thereby orientating molecules of E-O material 122 either perpendicular or parallel to the transmission axis between waveguide 120a to 120d. FIG. 2A depicts molecules 204 of active material 122 that are aligned perpendicular to the transmission axis. Therefore, incident light passes through switch junction 114 from waveguide section 120a to waveguide 120d. FIG. 2B depicts a parallel orientation of molecules 204. Accordingly, the incident light at the gap is reflected to the horizontal direction along waveguide section 120a by total internal reflection or strong reflection. Thus, incident light upon switch 114 does not pass through to waveguide section 120d and is maintained along waveguide section 120a, i.e., the light reflects off of E-O material 122 at gap 124c and continues along the route to toward output port 110 on the far right of FIG. 1A.

By controlling the electrical fields of gaps 124a, 124b, and 124c of optical switch 100, an input signal acquired at input port 102 can be directed to any one of the four output ports 104, 106, 108, or 110. In this manner, a 1×4 switch is achieved. Depending on the application, input port 102 and output ports 104, 106, 108, and 110 can be connected to fiber optic cables or any other optical conduit to transport light to and from optical switch 100. In a related embodiment, a 4×4 switch comprises four optical switches 100 stacked together. In this configuration, four 4×1 light combiners are included to combine the four corresponding output ports of each 1×4 switch. The result is a 4×4 switch that can selectively direct light from any one of the input ports to any of the four output channels in a non-blocking fashion. This embodiment can be adapted to a N×N optical switch by using any number (N) of 1×N switches and N number of N×1 light combiners. The gap can be filled with any electro-optical material with appropriate refractive index behavior. Further, the concept can be utilized for both multiplexed and single channel optical communications.

Referring again to FIG. 1A, waveguide sections 120a and 120b are shown having bending angles of 90 degrees to simplify illustration. However, for optimum performance the bends are smooth and at angles less than 90 degrees. Particularly, the optimum bending angle a few degrees and is such that power loss is minimal and internal reflection of incident light (in the reflective state) is maximized. FIG. 1B illustrates optical switch 100 with preferable bending angles.

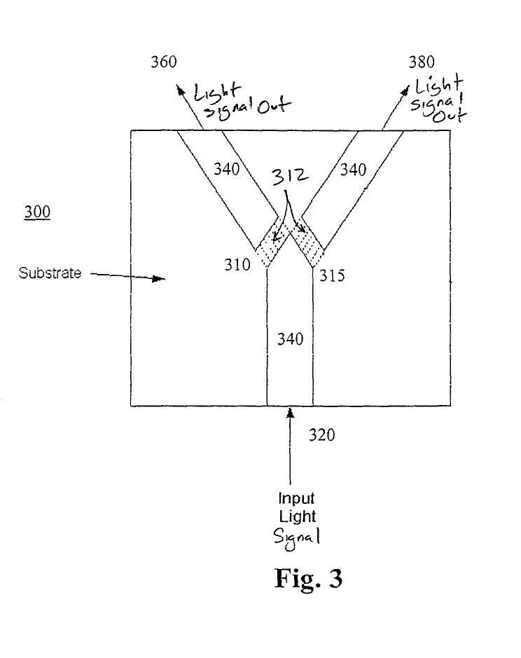

According to another embodiment of the invention, FIG. 3 depicts a 1×2 Y shaped optical switch 300 having a input port 320 and two output ports 360 and 380. Optical switch 300 includes gaps 310 and 315 filled with E-O polymer material 312 at the intersection of three waveguide sections 340. Each gap's applied voltage is separately controlled by sets of electrodes (not shown). Light incident through input port 320 can be selectively redirected to output port 360, output port 380, or both. For example, when gap 310 is in a reflective state and gap 315 is a transmission state, then incident light is directed to output port 380 and not to output port 360. When the gaps are in opposite states, incident light is directed to output port 360 and not output port 380. However, when both gaps are in the transmission state, then optical switch 300 acts a splitter directing splitting incident light into two beams, each beam traveling to an output port. When both gaps are in the reflective state, then incident light will not pass to either output port.

The novel devices and methods described above are particularly well suited for fiber switching (sometimes referred to as wavelength routing) systems, i.e., any optical wavelength on any input fiber can be directed to any output fiber, and is fully scalable up to at least a 1,000×1,000 scale without significant power loss. In other words, systems employing integrated cross connect switches can be configured to have any number of input and output fibers with any of the wavelengths (“λ”) on the input fiber being directed to any of the output fiber. For example, a 32×32 optical cross-connect switch is shown in FIG. 4 having four input fibers and four output fibers. Each input fiber carries a multiplexed optical signal comprising eight separate optical wavelengths. In this embodiment, system 400 comprises a 32×32 optical cross-connect switch 400 connected to four input fibers 420 and four output fibers 440. In operation, any λ on any of the four input fibers 420 can be directed to one of four output fibers 440. One of ordinary skill in the art would recognize that this and the following embodiments are exemplary only, and can be adapted to operate on any number of input or output fibers carrying any number of optical wavelengths.

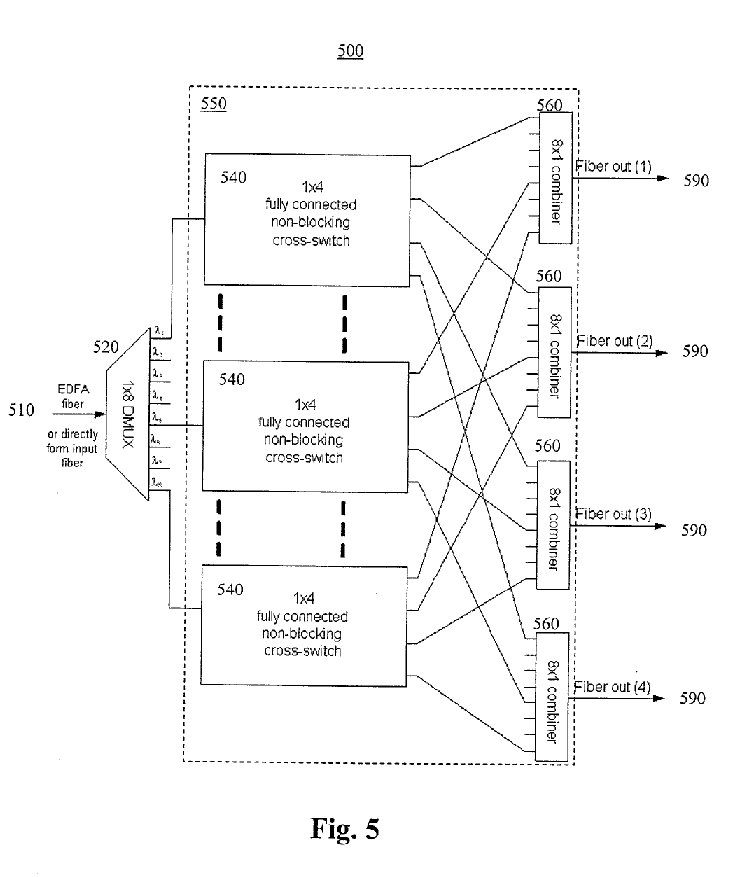

An 8×4 (one input fiber with 8 wavelengths and four output fibers) fiber switching system according to an embodiment of the invention is shown in FIG. 5. Fiber switching system 500 comprises input port 510; 1×8 demultiplexer (“DMUX”) 520; 8×4 cross-switch 550; and four (4) output ports 590. 8×4 cross-switch 550 comprises eight (8) 1×4 cross-switch devices 540 (for illustrative purposes only three are shown) based on the invention embodied in FIG. 1B and four (4) 8×1 combiners 560. Each cross-switch 540 is dedicated to one of the optical wavelength channels received from DMUX 520, which is only necessary if the input light is multiplexed. In operation, multiplexed light comprising eight (8) optical wavelengths is received at input port 510 via an optical fiber and demultiplexed into eight separate optical wavelengths signals by DMUX 520. Upon receiving a signal, cross-switch 540 directs the signal to one of the four combiners 560 from one of its output ports depending on the configuration of the internal switches of the cross-switch. Combiners 560 combine the signals received from all respective outputs of cross-switches 540 and direct the combined signal to a respective optical fiber connected at output port 590. In this way, any one of the eight input wavelength channels can be directed to any one of the four out going fibers in an independent, simultaneous, and non-blocking manner. The speed of the routing process is just that of operating the internal switching elements, e.g., changing the polarity of the electrodes, of the 1×4 cross-switch.

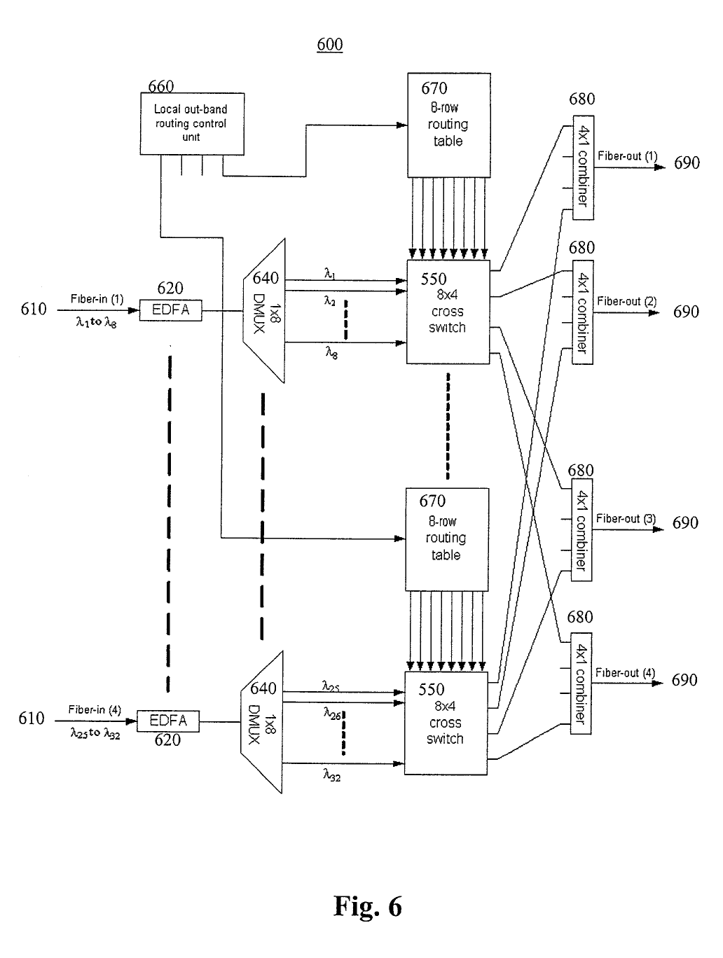

Configuration of the internal switches in an 8×4 switch can be implemented in an automated or locally controlled fashion as the following two embodiments exemplify. FIG. 6 depicts a 4-fiber×4-fiber, 32-channel, out-band locally-controlled and fully connected, optically transparent data routing system 600 employing four (4) 8×4 cross-switches 550 (only two are shown for simple illustration) according to an embodiment of the invention. Routing system 600 further comprises: four (4) input ports 610; optional EDFAs 620; four (4) 1×8 DMUXs 640; four (4) 4×1 combiners 680; and four (4) output ports 690. Each 8×4 cross-switch 550 is connected to one of four (4) 8-row routing tables 670. All four routing tables 670 are controlled by logical out-band routing control unit 660. “Out-band” refers to acquiring the desired routing information from means other than acquiring routing information directly from the optical channels themselves. For example, routing information is determined based on the desired provision of wavelength channels, optical network requirements, and necessary redundancy control and recovering. In operation, local control unit 660 sends out signals to routing tables 670, which control corresponding 8×4 cross-switches 550. After amplification, any input wavelength on any of the four input fibers connected to input ports 610 can be directed to any one of four output fibers connected to output ports 690.

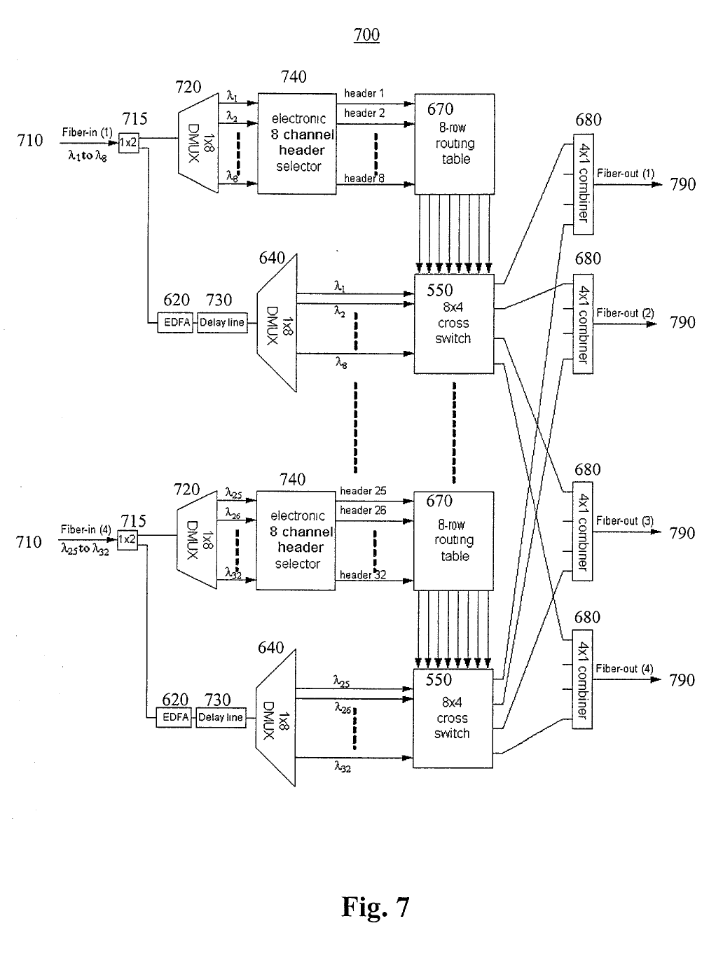

In an alternative embodiment, a self-routing data routing system 700 is shown in FIG. 7. Referring to this figure, data routing system 700 is a 4-fiber×4-fiber, 32-channel, in-band-controlled, i.e., self routing, fully connected optically transparent data router with optional amplification via EDFA. Data routing system 700 comprises similar components to system 600. However, local control unit 660 in system 600 is replaced by electronic eight (8) channel header selector 740 and DMUX 720. In operation, the signal on each input fiber at input port 710 is split into two beams by 1×2 splitter 715 and then demultiplexed by 1×8 DMUXs 640 and 720 into wavelength channels. Electronic header selector 740 strips the header information, comprising destination address information of the data packets carried in the wavelength channel of each wavelength channel independently and simultaneously. The pre-stored routing information in routing table 670 compares the header information with its “routing map” and decides the optimum output fiber path at output ports 790 for each wavelength channel. Therefore, each routing table 670 sends out a control signal to its respective 8×4 cross-switch 550 for each of the eight wavelength channels. The amplified wavelength channel from the other output of splitter 715 goes to the output channel in a bit-rate transparent optical fashion. The same operation is carried on each wavelength channel on an independent, simultaneous, and non-blocking manner. Delay 730 is provided to synchronize both optical paths. Those skilled in the art recognize that the above use of eight channels is exemplary only, and that any number of wavelength channels on each fiber can be used in devices and systems scaled accordingly.

Although the invention has been particularly shown and described with reference to several preferred embodiments thereof, it will be understood by those skilled in the art that various changes in form and details may be made therein without departing from the spirit and scope of the invention as defined in the appended claims.

I claim:

1. An optical switch comprising:
a first optical waveguide;
a second optical waveguide; and
a first active material disposed at a first switch junction between said first and second waveguides,
wherein a refractive index of said first active material comprises a first and second refractive index state, said first refractive index state having a refractive index substantially equal to refractive indexes of said first and second waveguides, and said second refractive index state having a refractive index less than refractive indexes of said first and second waveguides.

2. The optical switch of claim 1 wherein said optical switch is a planar device.

3. The optical switch of claim 2 wherein said planar device is an optical chip.

4. The optical switch of claim 3 wherein said first and second waveguides comprises a material selected from the group consisting of: silica crystal, silica glass, polymer, or any combination thereof.

5. The optical switch of claim 1 wherein said first active material is homogeneous.

6. The optical switch of claim 1 wherein said first active material is an electro-optical material, said first refractive index state results from a first electric field applied to said active material, and said second refractive index state results from a second electric field applied to said first active material, wherein said first and second electric fields are not identical.

7. The optical switch of claim 6 wherein said electro-optical material is a polymer or liquid crystal.

8. The optical switch of claim 6 wherein said electro-optical material has a refractive index that varies in the range of 1.42 to 1.50.

9. The optical switch of claim 6 wherein said electro-optical material has a switching time of less than 10⁻³ seconds, wherein said switching time is the time it takes to switch between said first and second refractive index states.

10. The optical switch of claim 6 further comprising means for generating said first and second electric fields.

11. The optical switch of claim 6 further comprising four or more electrodes for generating said first and second electric fields.

12. The optical switch of claim 1 wherein said first active material is a thermo-optical material, said first refractive index state results from a first thermal gradient applied to said first active material, and said second refractive index state results from a second thermal gradient applied to said active material, wherein said first and second thermal gradients are not identical.

13. The optical switch of claim 1 wherein said first refractive index state transmits substantially all light carried in said first waveguide through said active material to said second waveguide.

14. The optical switch of claim 1 wherein said second refractive index state transmits substantially zero of light carried in said first waveguide through said active material to said second waveguide.

15. The optical switch of claim 14 wherein substantially all of said light is reflected off of an incident surface of said active material.

16. The optical switch of claim 1 further comprising:
a third optical waveguide;
a second active material disposed at a second switch junction between said first and third waveguides,
wherein a refractive index of said second active material comprises a third and fourth refractive index state, said third refractive index state having a refractive index substantially equal to the refractive indexes of said first and third waveguides, and said fourth refractive index state having a refractive index less than said refractive indexes of the first and third waveguides.

17. A 1×N optical switch comprising:
one input optical port;
N number of output optical ports;
N number of waveguides; and
N-1 or more number of optical switches as claimed in claim 1.

18. The optical switch of claim 17 wherein light entering said input optical port exits only one of said N number of output optical ports.

19. A N×N optical switch comprising:
N number of 1×N optical switches as claimed in claim 14, and
N number of N×1 combiners, wherein each of said N×1 combiners comprises N input optical ports and one output optical port.

20. An optical switching method comprising the steps of:
transmitting light in a first waveguide;
striking a surface of an active material with said light, wherein said active material is disposed between said first waveguide and a second waveguide;
adjusting a refractive index magnitude of said active material.

21. The method of claim 20 wherein said refractive index magnitude is substantially equal to refractive indexes of said first and second waveguides.

22. The method of claim 21 further comprising the step of transmitting substantially all of said light through said active material to said second waveguide.

23. The method of claim 20 wherein said refractive index magnitude is less than said refractive indexes of said first and second waveguides.

24. The method of claim 23 further comprising the step of blocking substantially all of said light from passing through said active material to said second waveguide.

25. The method of claim 23 further comprising the step of reflecting substantially all of said light off of said surface of said active material.

26. The method of claim 20 wherein said adjusting step comprises applying an electric field to said active material.

27. The method of claim 20 wherein said adjusting step comprises applying a thermal field to said active material.

28. A wavelength routing system comprising:
an input optical port;
a plurality of output optical ports;
an optical cross-switching planar device optically connected to said input and output optical ports, wherein said chip comprises at least one refractive index matching switching element; and
wherein said wavelength routing system directs any optical wavelength channel received on said input optical port to any of said output optical ports.

29. The system of claim 28 further comprising an EDFA optically connected between said input optical port and said planar device.

30. The system of claim 28 further comprising:
one or more additional optical cross-switching planar devices optically connected to said input and output optical ports, wherein each additional planar device comprises at least one refractive index matching switching element; and
a DMUX, wherein an input of said DMUX is optically connected to said input optical port and a plurality of outputs of said DMUX are optically connected to said optical planar device and said additional optical planar devices, wherein each of said DMUX outputs carry a single optical wavelength channel.

31. The system of claim 30 further comprising a number of light combiners, wherein said number is equal to a number of said plurality of optical output ports, wherein each of said light combiners is optically connected to said optical planar device and said additional optical planar devices.

32. The system of claim 31 wherein said system is integrated on a chip.

33. The system of claim 28 further comprising:
a routing table for directing said received optical wavelength channels to any of said output optical ports

34. The system of claim 33 further comprising a routing control unit for configuring said routing table.

35. The system of claim 33 further comprising a electronic heading selector for configuring said routing table.

36. A method for fabricating an optical switch planar device comprising the steps of:
depositing a first optical cladding layer on a wafer substrate;
depositing a layer of waveguide material on said first cladding layer, wherein said layer of waveguide material forms a plurality of waveguide sections disconnected by one or more gaps;
depositing a refractive index active material in said one or more gaps; and
depositing a second optical cladding layer on said layer of waveguide material.

37. The method of claim 36, wherein said active material is an electro-optical material.

38. The method of claim 37, further comprising the step of connecting a plurality of electrodes to said device, wherein said plurality of electrodes control electrical fields present at said gaps.

39. The method of claim 36, wherein said active material is a thermo-optical material.

40. The method of claim 39, further comprising the step of connecting one or more electrodes to said device, wherein said one or more electrodes control a temperature at each of said gaps.

41. The method of claim 36, further comprising the step of attaching a cover to said second optical cladding.
